(19) United States
(12) Patent Application Publication
(10) Pub. No.: US 2018/0361420 A1
(43) Pub. Date: Dec. 20, 2018

(54) LOW FREQUENCY ELECTROSTATIC ULTRASONIC ATOMISING NOZZLE

(71) Applicant: JIANGSU UNIVERSITYY, Jiangsu (CN)

(72) Inventors: Jianmin GAO, Jiangsu (CN); Yiming CHEN, Jiangsu (CN); Qiang XU, Jiangsu (CN)

(21) Appl. No.: 15/781,385

(22) PCT Filed: Apr. 28, 2016
(86) PCT No.: PCT/CN2016/080434

§ 371 Date: Jun. 4, 2018

(30) Foreign Application Priority Data
Apr. 1, 2016 (CN) 201610198692.4

(51) Int. Cl. B05B 17/06; B05B 5/053

(52) U.S. Cl. CPC B05B 17/0607; B05B 5/053; B05B 17/0653

(57) ABSTRACT

A low frequency electrostatic ultrasonic atomising nozzle, relating to electrostatic atomisers in the field of agricultural engineering, and comprising a transducer rear cover plate (5), a piezoelectric ceramic (6), a transducer front cover plate (18), a nozzle variable amplitude rod (3), and a tightening screw (12), the tightening screw (12) passing in turn through circular central holes of the transducer rear cover plate (5), the piezoelectric ceramic (6), and the transducer front cover plate (18), the axial centre of the nozzle variable amplitude rod (3) being provided with a liquid intake channel (4), a gas intake channel (7) being provided at a position offset from the axial centre, and the top part of the nozzle variable amplitude rod (3) being machined into a concave spherical surface, the concave spherical surface being provided with a suspension ball (8). The suspension ball (8) is rotated at high speed using compressed air in an axially eccentric motion, and electrode electrification causes the suspension ball (8) to generate an electric field, such that the atomised drops produced by means of low frequency ultrasonic atomisation are further electrostatically atomised, and the electrostatically charged drops are sprayed from the nozzle. The present low frequency electrostatic ultrasonic atomising nozzle solves the problem of the difficulty for low frequency ultrasonic atomising nozzles to produce ultrafine atomised droplets, and electrostatically charges the atomised droplets, thereby increasing the adhesion of the atomised droplets and enabling same to more effectively adhere to a crop.

### FIELD OF THE INVENTION

The present invention relates generally to an ultrasonic nozzle and more particularly it relates to an ultrasonic nozzle that utilizes an electrostatic apparatus and sonic levitation mechanism.

### BACKGROUND OF THE INVENTION

Ultrasonic atomization is the use of electronic ultra-high frequency oscillation principle. Besides, the ultrasonic generator working with a specific frequency of oscillation current produced a high-frequency power signal and converted the signal towards the ultrasonic mechanical vibration through the transducer. Moreover, the ultrasonic vibration is propagated through a medium that needs to be atomized, and it makes the formation of surface tension wave which is formed at the gas-liquid interface. Due to ultrasonic cavitation, the surface tension waves cause liquid molecule force and make the liquid become droplets from the liquid surface. It is the primary process of liquid atomization by using ultrasonic waves. The ultrasonic atomization can form many droplets size up to the micron level. The ultrasonic atomization has many advantages in the field of agricultural engineering because it can form small droplet size and has a wide range of applications in the field of agricultural engineering. Considering, the high-frequency ultrasonic atomization (working frequency above 1 MHz) can change the physical and chemical properties of the atomized liquid to a large extent. Therefore, it is not suitable for the field of atomization cultivation (Aeroponics system) and plant protection. However, the low-frequency ultrasonic atomization has less effect on the physical and chemical properties of the atomized liquid. But the main problem associated with low-frequency ultrasonic atomization is that it thin's too large droplets, resulting in reduced adhesion on the leaves and roots of the crops.

A large number of research studies have shown that the charge can reduce the liquid surface tension and atomization resistance. Moreover, when the droplets carry the same charge, under the action of the electric field, it will break the large liquid molecules into smaller droplets with more uniform diameter distribution. The electrostatic atomization has been widely used in many applications include pesticide spraying, industrial spraying, material preparation, fuel combustion, industrial dust and desulfurization, particle aggregation and separation, and many other fields. The advantage of electrostatic spray is that the droplet adhesion characteristics are excellent. However, because of the technical constraints, the electrostatic voltage of the critical voltage is between several kilo-volts to tens of thousands volt, which is called high-voltage electrostatic atomization. High-voltage electrostatic atomization has the following shortcomings: the voltage of high-voltage electrostatic atomization is between several kilo-volts to tens of kilo-volts, which is a great security risk for the operator; high-voltage static electricity that beyond a certain extent will hurt the crops, and low-voltage electrostatic will promote the growth of crops; the structure of high-voltage electrostatic spray is complex, demanding high manufacturing materials, especially insulation properties; the most important thing is that the high-voltage electrostatic needs high-cost equipment.

### SUMMARY OF THE INVENTION

The present invention aims to overcome the shortcomings of the prior art and to provide a low-frequency electrostatic ultrasonic atomizer which produces ultrafine charged droplets under low-frequency ultrasound and low static voltage to improve the adhesion of droplets to the crop.

In order to achieve the above objects, the present invention adopts the following technical scheme:

The low-frequency electrostatic ultrasonic atomization nozzle comprises a transducer back cover, piezoelectric ceramics, a transducer front cover, an ultrasonic horn and a fastening screw. Furthermore, the fastening screw is set through the transducer back cover, the piezoelectric ceramics and the center round hole of the transducer front cover in sequence. The diameter of the fastening screw is smaller than the center hole of the piezoelectric ceramic to prevent the short circuit between the fastening screw and the piezoelectric ceramic, affecting the normal operation of the nozzle. The transducer back cover, the piezoelectric ceramics, and the transducer front cover constitutes the vibrator part of the low-frequency electrostatic ultrasonic atomizing nozzle. The length of the ultrasonic horn is arranged at the half-length of the ultrasonic wave, and the ultrasonic horn is provided with an inlet channel in the axial center. The rear part of the ultrasonic horn is provided with liquid in the radial direction which is connected to the liquid inlet channel. An intake channel is arranged at an offset position from the axial center. The rear portion of the ultrasonic horn is provided with compressed air in the radial direction connected to the intake channel. The top of the ultrasonic horn is machined into a concave spherical surface, and a levitating ball is arranged on the concave spherical surface. Furthermore, the radius of curvature of the levitating ball is the same as the radius of curvature of the concave spherical surface of the ultrasonic horn. This design can form a focused ultrasound suspension system which can generate more acoustic levitation force. Apart from this, the levitating ball is made of the metallic conductor. The outer surface of the levitating ball is arranged in the V-shaped annular groove, and the tip of the charging needle is provided in the V-shaped annular groove. The rear end of the charging needle is restrained by a spring so as to be in regular contact with the suspended ball; the charging needle is covered with an insulating sleeve, and it is mounted on the bracket by means of a set, and the bracket is mounted on the flanges of the ultrasonic horn by means of set screws. The flange is designed at the node of the ultrasonic horn.

When the nozzle does not work, because of gravity and charge injection pressure, the levitating ball firmly attached to the top of the nozzle. However, when the nozzle is at work, under the drive of the piezoelectric ceramics, the front and back cover of the vibrator produce ultrasonic vibration, resonate with the horn, and generate the focused radiation sound field at the semicircular end. The sound field makes the levitating ball overcome the gravity and the force from the charging needle, and let the ball suspend upward to form a gap between the levitating ball and the top face of the horn. At the same time, the levitating ball goes with high-speed rotation by the eccentric aerodynamic effect. In order to ensure that the ball can produce acoustic suspension phenomenon, the front of the nozzle is designed as a concave spherical surface, resulting in a focused ultrasound suspension system to form greater acoustic leeway.

There is an intake channel in the eccentric axial position of the nozzle, and the diameter of the inlet channel is about 1-2 mm. In the nozzle work, the flow rate of 50-100 m/s of compressed air is passed into the intake channel. Acted by compressed air, the levitating ball goes with high-speed rotation, so that the droplets cannot stick on the suspended ball. Meanwhile, high-speed rotation of the levitating ball colliding with droplets makes droplets atomized again.

The depth of the annular groove on the outer surface of the levitating ball is 1-2 mm. wherein the diameter of the insulating sleeve is 0.2-0.4 mm greater than the diameter of the spring and 0.05-0.1 mm less than the diameter of the socket. The spring can resist the insulation sleeve and restrict the charging needle to reciprocate in the socket.

The ultrasonic horn and transducer back cover is made of insulated ceramic materials. This ensures that the electrostatic field generated by the levitating ball does not affect the normal operation of the piezoelectric ceramics.

The levitating ball and the charging needle are made of copper. The surface of the charging needle is provided with an insulation sleeve to prevent the spring and sleeve from coming into direct contact with the charge. The diameter of insulation sleeve is higher than the spring diameter 0.2-0.4 mm and less than the sleeve diameter 0.05-0.1 mm. It can ensure that the charging needle and the levitating ball have regular contact. The upper surface of the socket is fixed to the bracket by welding. At the same time, a small hole is formed at the center of the contact of the holder and the sleeve so that the live wire can go into the socket and connect directly the charging needle to ensure the charging needle charged.

The bracket is a rectangular frame. The bracket and the horn are connected with bolts. The nuts and the ultrasonic horn are fitted with gaskets. The brackets and horns are bolted and have a simple structure to facilitate disassembly during installation or repairing time. At the same time, there are gaskets between nuts and the horn of the nozzle to prevent the nuts from loosening during operation.

The main body of the ultrasonic vibration consists of the horn, piezoelectric ceramics, the front cover of the transducer, back cover of the transducer and the socket screw. The frequency of the main body is 25-30 kHz. The charging needle applies a static voltage of less than 500-2000 V to the suspended ball.

The nozzle drive circuit consists of choke inductor L_{RFC}, switch S, equivalent parallel capacitor C, series resonant inductance L₁, series resonant capacitor C₁ and impedance matching capacitor C_{P}.

The nozzle drive circuit is simple and efficient, which is a single-ended circuit and mainly composed of six parts: choke inductor L_{RFL}, switch S, equivalent parallel capacitor C (sum of switch input capacitor, distributed capacitor and external capacitor), series resonant inductor L₁, series resonant capacitor C₁, and impedance matching capacitor C_{P}. The operating principle is as follows: the square wave signal of working frequency f (nozzle series resonant frequency) control the turning on and turning off of the switch S. At this time, switch S pole output pulse voltage. Through the frequency selection network C-C₁-L₁-C_{P}, the nozzle at both ends of the switching frequency f harmonic signal is suppressed, and the base frequency signal is selected. In this way, the two ends of the nozzle can be obtained the square wave signal with the frequency of sinusoidal AC signal. In addition, the frequency selective network can be used to adjust the load impedance. Simply put, when the switch S is operated by the active square wave signal cycle, the DC energy from the power supply can be converted to AC energy. Frequency selection network can only let the base frequency current flow, thus encouraging the nozzle to work.

A simple analysis for ultrasonic atomization drive circuit in the three stages of the work process:

Firstly, the choke inductance L_{RFL} needs to be large enough to allow only the DC signal to pass through, while the AC signal has a large impedance, thereby suppressing the AC signal through. This causes the supply current not to drastically changes when the switch is turned on or off. Therefore, the input current can be considered as a constant flow.

Secondly, the fundamental frequency resonant circuit quality factor needs to be high enough. The flow passing through the ultrasonic nozzle can be regarded as the sine wave.

Finally, the conduction resistance of the switch S is ignored. And switch S can instantaneously complete the process of turning on or off, that is the time for switch tube S to rise or fall to zero.

Compared with the similar type of atomizer, the invention has the following technical effects:

1. By low-frequency ultrasonic atomization, electrostatic atomization, and centrifugal, the liquid is atomized several times, so this nozzle can produce finer electrified droplets, increasing possibility of adsorbing by plant. Levitating ball in the sound field achieves suspension under the action from the radiation. And in the eccentric aerodynamic action, the levitating ball goes with high-speed rotation, so that the charged droplets in the centrifugal force under the high-speed can fly out and droplets do not stick to the ball. The liquid is vibrated by the ultrasonic horn for the first atomization process. Under the action of the electrostatic field, the droplets are subjected to the second atomization. Finally, the droplets collide with the levitating ball at high speed for the third atomization. The liquid in the first atomization, the particle size is less than 60 microns, and the electrostatic secondary atomization required voltage significantly reduced, easy to achieve low-voltage electrostatic atomization. The droplets were high-speed spray out by the centrifugal force and aerodynamic compound effect after the third atomization.

2. The drive circuit structure is simple with high efficiency. The parasitic parameters of the circuit are effectively used. The junction capacitance of the switch tube is absorbed by the parallel capacitor of the resonant circuit, which can effectively reduce the influence of parasitic parameters on the circuit performance. The circuit produces little heat in the process of working, which is able to drive the nozzle for a long time. At the same time, it has a high degree of reliability and can reduce the use of maintenance costs in the process and improve production efficiency.

### BRIEF DESCRIPTION OF THE DRAWINGS

The present disclosure will be described with reference to the accompanying drawings, wherein like numbers reference like elements.

FIG. 1 is the schematic diagram of static ultrasonic atomization nozzle structure.

FIG. 2 is a side view of static ultrasonic atomization nozzle.

FIG. 3 is the schematic diagram of 3-D explosion of electrostatic ultrasonic atomization nozzle.

FIG. 4 is the diagram of the working process of the nozzle.

FIG. 5 is the analysis of the force of the suspended ball.

FIG. 6 is the schematic diagram of the atomization process of droplets.

FIG. 7 is the schematic diagram of the bottom structure of the electrostatic atomization nozzle.

FIG. 8 is the schematic diagram of the bottom of the electrostatic atomization nozzle.

FIG. 9 is the diagram of nozzle bracket connection.

FIG. 10 is the schematic diagram of the stent and charging needle structure.

FIG. 11 is a diagram of nozzle drive circuit.

FIG. 12 is the simplified model of the nozzle drive circuit.

FIG. 13 is the waveform figure of working principle that the nozzle drive circuit works at different stages.

In those figures, 1—set; 2—charging nozzle; 3—ultrasonic horn; 4—inlet channel; 5—back cover; 6—piezoelectric ceramic; 7—intake channel; 8—suspended ball; 9—insulation sleeve; 10—spring; 11—bracket; 12—tightening screw; 13—bolt; 14—gasket; 15—nut 16—nutrient solution; 17—compressed air; 18—front cover;

L_{RFL}—choke inductor; S—switch; C—equivalent parallel capacitor (sum of switch tube input capacitor, distributed capacitor and external capacitor); L₁—series resonant inductor; C₁—series resonant capacitor; Cₚ—impedance matching capacitor; Vgs—the drive signal of the switch S; Vs—the voltage waveform across the switch S; is—the current flowing through the switch S; ic—current flowing through the parallel capacitor C; i—current flowing through the nozzle.

### DESCRIPTION OF EXEMPLARY EMBODIMENTS

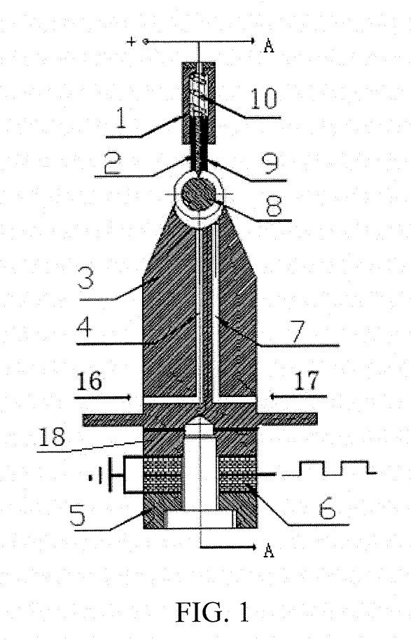

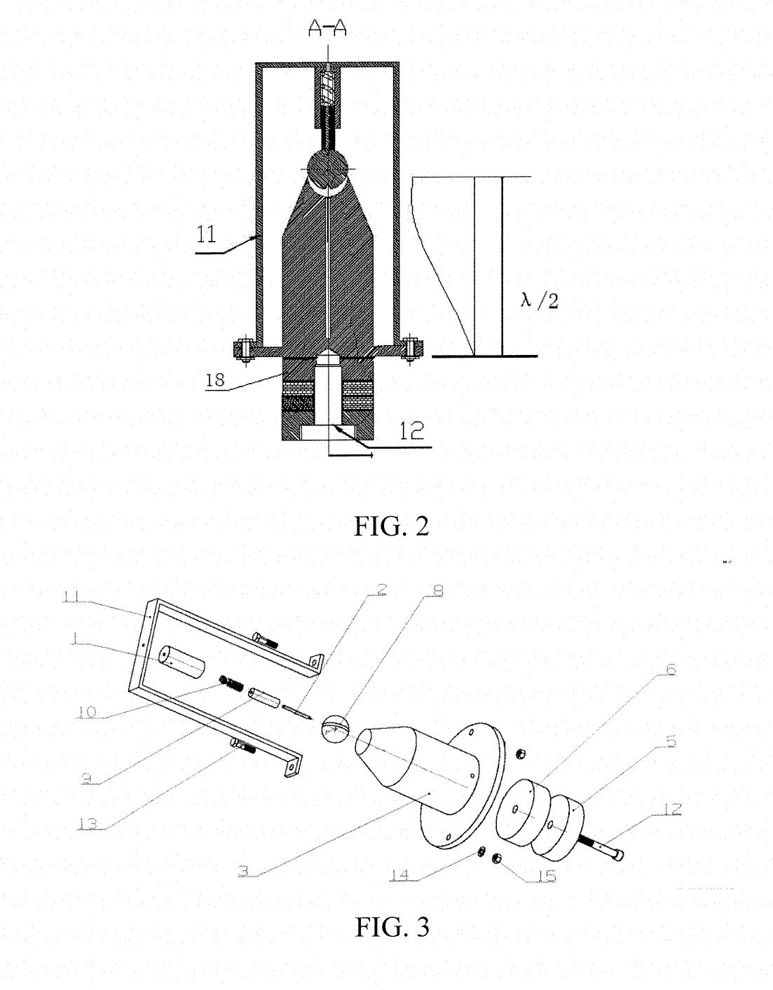

As shown in FIG. 1 and FIG. 2, the nozzle includes a horn 3, a front cover 18, a back cover 5, and piezoelectric ceramics 6 that generate ultrasonic vibrations. Among them, the vibration part of the nozzle is composed of three parts: a front cover 18, piezoelectric ceramics 6 and a back cover 5. The length of the horn 3 is half-wavelength. The inlet channel 4 is designed in the axial center of the nozzle. The gas intake channel 7 is designed to deviate from the axial center at a certain position. The top of the nozzle is machined as a concave hemisphere and has a levitating ball 8 on it. The material of the levitating ball 8 is a metal conductor with a diameter of 15 mm and the outer surface of the levitating ball 8 has a V-shaped annular groove having a depth of about 1-2 mm. The top of the charging needle 2 is mounted in a V-shaped annular groove. The top of the charging needle 2 is provided with a spring 10 restraint, which ensures that the tip of the charging needle 2 can be in constant contact with the levitating ball 8. The surface of charging needle 2 has an insulation sleeve 9 mounted on the bracket 11 by a set 1. In addition, the bracket 11 is mounted at the node of the nozzle.

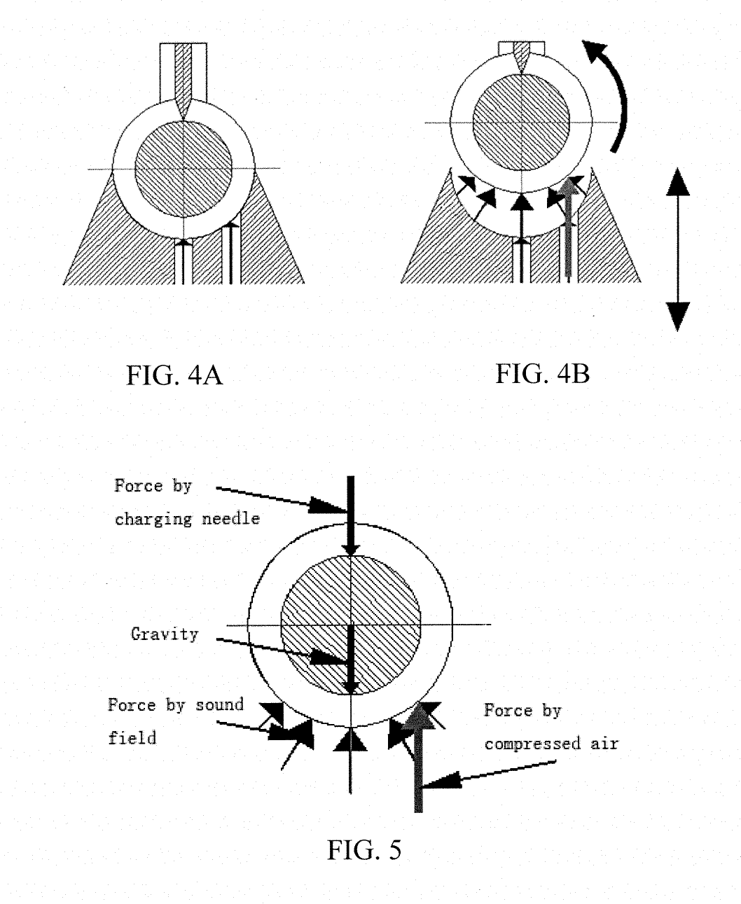

The operation of the nozzle is shown in FIG. 4. In FIG. 4, the levitating ball 8 is close to the top end of the nozzle due to the gravity and pressing force from the charging needle 2. When the nozzle is working, under the piezoelectric ceramics 6 drive, the horn 3 and the piezoelectric ceramic 6 resonance, resulting in ultrasonic vibration and producing focused radiation field in the semi-circular end position. Levitating ball 8 overcome the gravity and the force from the charging needle 2, under the action of the sound radiation force, suspending upward. So, it forms a gap between the levitating ball 8 and the top face of the horn. The intake channel 7 is located in the eccentric axial position of the nozzle, and the diameter of the inlet channel 7 is about 1 mm. When the nozzle is operated, the compressed air 17 is supplied with the flow rate of 50-100 m/s in the intake channel 7. The compressed air 17 drives the levitating ball 8 to rotate at high speed so that the droplets do not stain levitating ball 8. The high-speed rotation of the levitating ball 8 and many droplets collide so that droplets are atomized again. The force analysis of the levitating ball 8 is shown in FIG. 5.

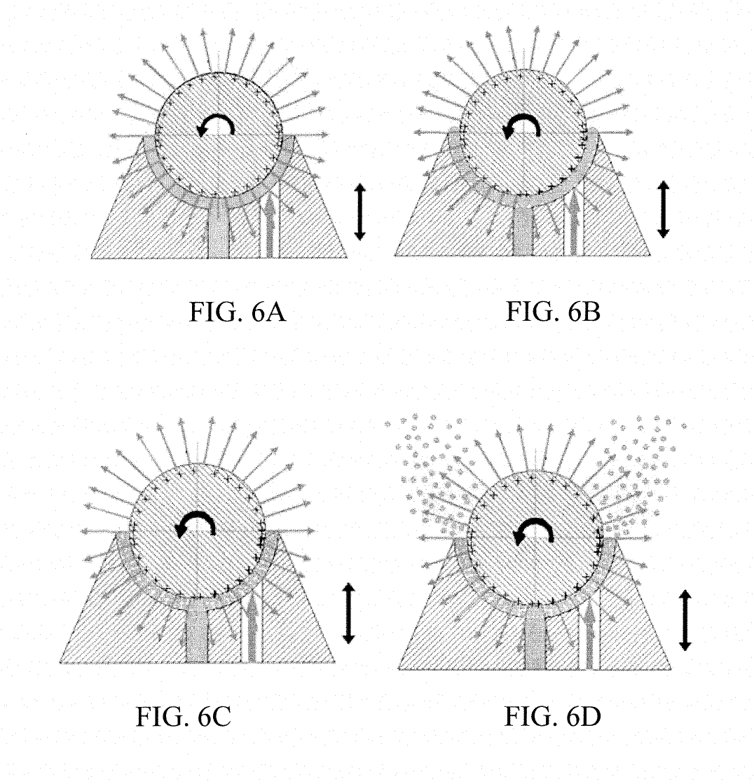

The atomization process of the droplet is shown in FIG. 6. The atomization process is divided into four stages:

(1) The liquid becomes a liquid film at the top surface of the ultrasonic nozzle. As shown in FIG. 6 (a).

(2) The liquid is atomized by ultrasonic action on the hemispherical atomized end face. As shown in FIG. 6 (b). The cavitation effect of the ultrasonic wave on the liquid results in the generation of micro-shocks to produce atomization. Acted by The high-frequency vibrating air flow with the turbulence, pulsed liquid film will be drawn into filaments and further broken into droplets and aerosol.

(3) The liquid is subjected to secondary atomization by the electric field generated by the charged levitating ball 8. As shown in FIG. 6 (c). High-voltage static electricity reduces the surface tension and viscous resistance of the liquid, making the liquid easily broken into smaller droplets, and making the droplet size distribution even more uniform. When droplets are charged, the charged droplets are easy to be secondly atomized in the high voltage electrostatic field, which further reduces the droplet size. At the same time, charged droplets in the charge between the repulsion, the degree of dispersion increased. And the charged droplets can be attracted to the leaves with the opposite polarity of the charge so that they can be easily captured by the target under the action of polarization force and gravitational force.

4) The liquid is ejected by the centrifugal force of the aerodynamic force and the high-speed rotation of the levitating ball 8, which is shown in FIG. 6 (d).

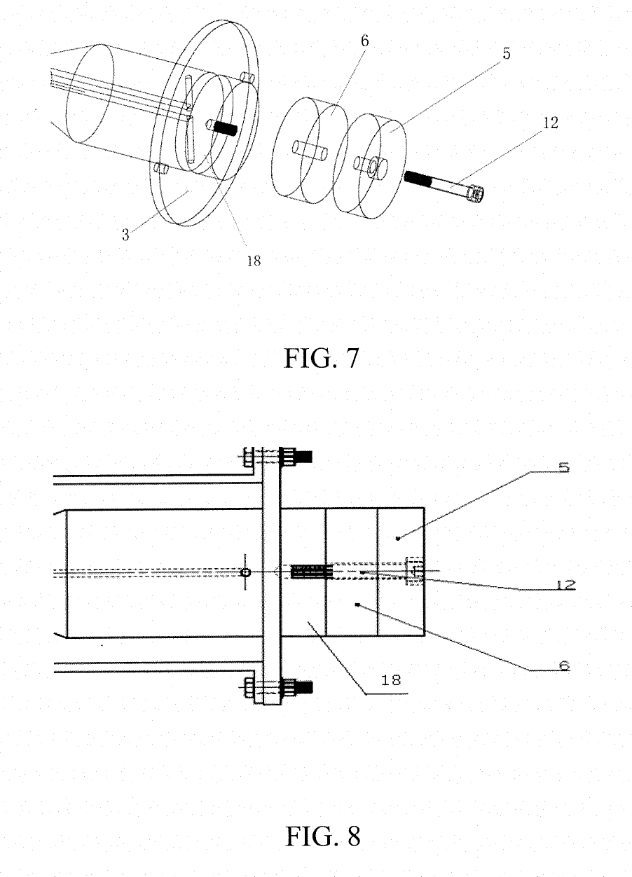

The lower end of the nozzle connection structure is shown in FIG. 7 and FIG. 8. A set screw 12 was used through the transducer back cover 5 and the piezoelectric ceramics 6, connected to the tip of the ultrasonic horn 3 while fixing the piezoelectric ceramic 6 and the front and back covers. The diameter of the socket screw 12 is smaller than the radius of the center hole of the piezoelectric ceramics 6, and it can prevent the short circuit caused by the contact between the socket screw and the piezoelectric ceramics, which might affect the normal operation of the nozzle.

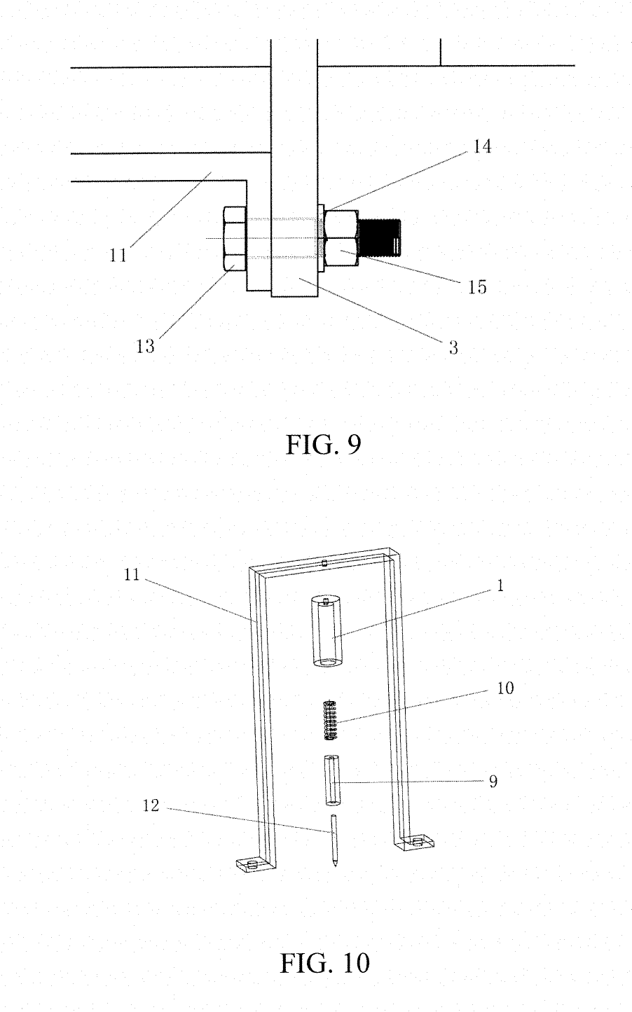

As shown in FIG. 8 and FIG. 9, the bracket 11 and the horn 3 are connected by bolts 13. This structure is simple, and it is easy to install and disassembled during maintenance. At the same time, it can increase the preload to prevent loosening, does not cause the connection material composition phase change. The gasket 14 is sandwiched between the nuts 15 and the ultrasonic horn 3, which prevents the nut 15 from loosening during the operation of the nozzle while increasing the bearing area and preventing the screw 12 bolts from damaging.

As shown in FIG. 10, the surface of the charging needle 2 is designed with an insulation sleeve 9 to prevent the spring 10 and set 1 from being in contact with electricity. The diameter of the insulation sleeve 9 is greater than the diameter of the spring 10, less than the inner diameter of the socket 1, and the spring 10 can resist the insulation sleeve 9 so that the charging needle 2 reciprocates in the socket 1. The upper surface of the socket 1 is fixed to the bracket 11 by welding. At the same time, in the center of the bracket 11 and the socket 1, a small hole is designed to let the live wire can be deep into the socket 1, directly connected to the charging needle 2. It can make the charge needle 2 charged, to achieve the goal of electrostatic atomization.

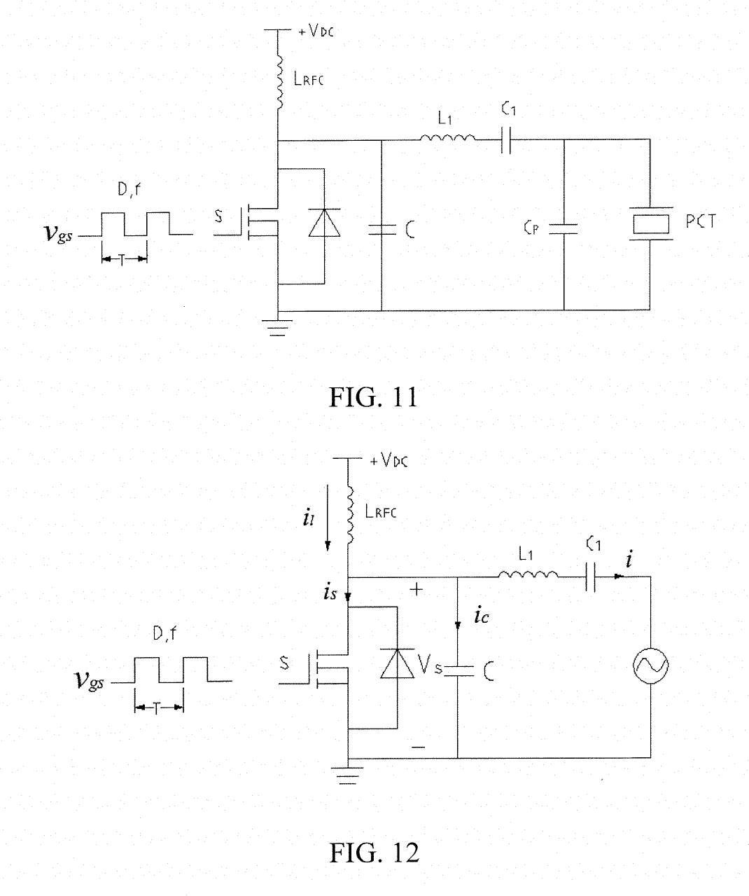

The driver circuit of the nozzle is shown in FIG. 11. The structure of the circuit is simple, and it is a single-ended circuit, mainly composed of six parts, namely: choke inductor L_{RFL}, switch S, equivalent parallel capacitor C (sum of switch input capacitor, distributed capacitor, and an external capacitor), series resonant inductor L₁, series resonant capacitor C₁, impedance matching capacitor C_{P}. The working principle is as follows: the square wave signal of working frequency f (nozzle series resonant frequency) control the turning on or off of the switch S. At this time, switch S pole output pulse voltage. The nozzle at both ends of the switching frequency f harmonic signal is suppressed, through the frequency selection network C-C₁-L₁-Cₚ, and the base frequency signal is selected. In this way, two ends of the nozzle can be obtained with the square wave signal with the frequency of sinusoidal AC signal. On the other side, the frequency selective network can be used to adjust the load impedance. Simply put, when the switch S is operated by the active square wave signal cycle, the DC energy from the power supply can be converted to AC energy. Frequency selection network can only let the base frequency current flow, thus encouraging the nozzle work.

A simple summary for ultrasonic atomization drive circuit in the various stages of the work process:

Firstly, the choke inductance L_{RFL} needs to be large enough to allow only the DC signal to pass through, while the AC signal has a large impedance, thereby suppressing the AC signal through. This causes the supply current not to drastically changes when the switch is turned on or off. Therefore, the input current can be considered as a constant flow.

Secondly, the quality factor of the fundamental frequency resonance circuit needs to be high enough that the flow through the ultrasonic nozzle can be regarded as a sine wave.

Finally, the conduction resistance of the switch S is ignored. And switch S is instantaneous opened or closed, that is the time that switch S rise or fall to zero.

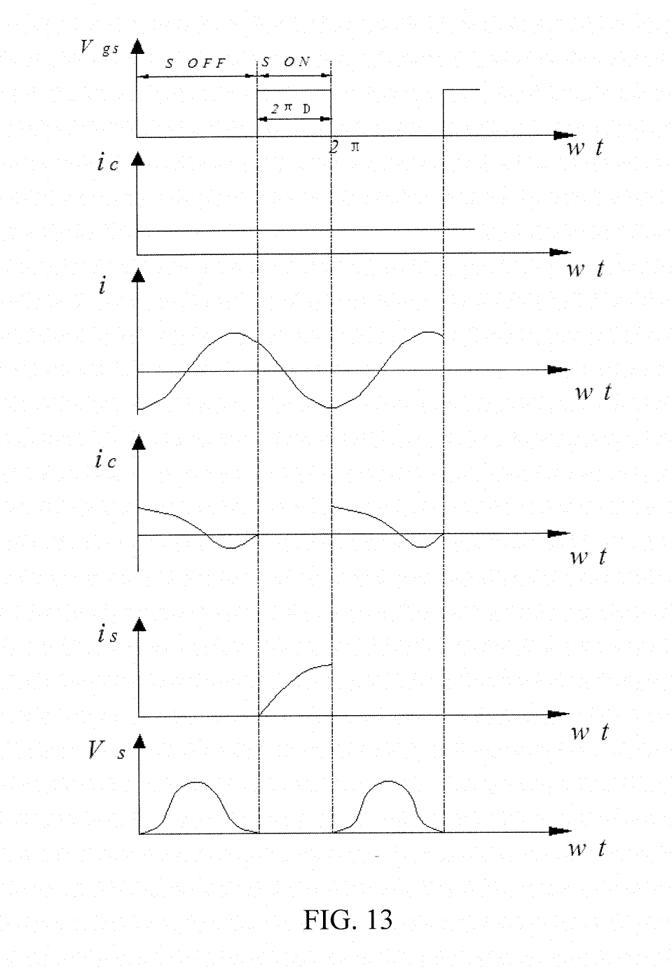

As shown in FIG. 12 and FIG. 13, the drive circuit is simplified to be analysed. Where V_{gs} is the driving signal of the switch S, Vₛ is the voltage waveform across the switch S, iₛ the current flowing through the switch S, i_{c} is the current flowing through the parallel capacitor C, and i is the current flowing through the nozzle.

(t₀≤t≤t₁) Stage I

Before t₀ moment, the switch S is turned on, and the DC voltage V_{DC} charge the choke inductance L_{RFC} and let it storage energy. The parallel capacitor C beside the switch S is short-circuited. Switch tube S, resonant inductance L₁, resonant capacitor C₁, and nozzle form a series resonant circuit. At time t₀, switch S is disconnected. As the inductor current cannot be mutated, the current flowing through the switch S is instantaneously turned to the parallel capacitor C next to the switch S. The voltage across the parallel capacitor C rises gradually from zero. At this point, the parallel capacitance C, resonant inductance L₁, resonant capacitor C₁ and the nozzle together constitute a series resonant circuit. The energy stored in the choke inductance L_{RFC} previously is transferred to the resonant circuit. As the i_{C} current decreases, the Vs reaches the highest value until it is reduced to zero; when i_{C} changes from zero to negative, the parallel capacitor C begins to discharge; when the parallel capacitor C discharge complete, then the current flowing through the RF choke i₁ equals to the current i in the resonant circuit, and the switch S turns on immediately and enters the next stage. At this time, the switch S with the zero current, zero voltage switch, and the switching conduction loss is almost zero.

(t₁≤t≤t₂) Stage II

At time t₂, the switch S is turned on and shunt capacitor C is shorted. According to the Kirchhoff current law, the current of the choke inductance L_{RFC} is divided into two conditions, one flowing goes through the switch S, and the other goes through the nozzle. As the resonant current i gradually decrease, the current is that flowing through the switch S is increasing. The resonant circuit consists of series resonant capacitor C₁, series resonant inductance L₁, and nozzle. The resonant capacitor C₁ and the resonant inductor L₁ stored in the energy exchange, one reaches the maximum, the other just down to zero. When the resonant capacitor C₁ reaches the resonant peak, the resonant current i drops to zero. Thereafter, the resonant capacitor C₁ is discharged to the resonant inductor L₁, and the resonant current i is reversed. And so on, the circuit work into the next high-frequency cycle of the working stage I.

This low-frequency electrostatic atomization nozzle drive circuit has the following advantages: The parasitic parameters of the circuit can be effectively absorbed. The junction capacitance of the switch tube is absorbed by the parallel capacitor of the resonant circuit, which can effectively reduce the influence of parasitic parameters on the circuit performance.
1. Circuit working efficiency is high. From the above analysis, the current i_{S} flowing through the switch S, and the voltage Vs across the parallel capacitance C of the switch are not present at the same time. Thus, at any one time, the product of i_{S} and V_{S} is zero, then the loss of switch S is almost zero. The ideal efficiency of 100% and the actual efficiency reach up to 90% or more.

The embodiment is a preferred embodiment of the present invention, but the invention is not limited to the above-described embodiments. It will be apparent to those skilled in the art that any obvious modifications, substitutions, or variations are intended to be within the scope of the present invention without departing from the spirit of the invention.

1. A low-frequency electrostatic ultrasonic atomization nozzle, the device comprising: a back cover; piezoelectric ceramics; a transducer front cover; further the transducer back cover, the piezoelectric ceramics and the transducer front cover constitute a ultrasonic vibrator; an ultrasonic horn whose length is disposed as half-length of an ultrasonic wave, having a liquid inlet channel configured in the axial center of the ultrasonic horn, an intake channel configured at a position deviated from the axial of the ultrasonic horn and used for injecting compressed air, and having a concave spherical surface used for levitating ball; a fastening screw, wherein the fastening screw is disposed through center holes of the transducer back cover, the piezoelectric ceramics and the transducer front cover in sequence; a levitating ball having a V-shaped annular groove on its outer surface and made of metallic conductor; a charging needle restrained by a spring and the V-shaped annular groove on the levitating ball so as to charge the levitating ball uninterruptedly; an insulating sleeve used for insulating the charging needle; a socket used to connect the bracket and the insulating sleeve; a bracket connected with the flanges of the ultrasonic horn by screws and used for fixing the socket; a spring fit in the insulating sleeve and used for making the charging needle contact the charging needle uninterruptedly.

2. The device of claim 1, wherein the depth of the annular groove on outer surface of the levitating ball is 1-2 mm.

3. The device of claim 1, wherein the levitating ball and the charging needle are made of copper.

4. The device of claim 1, wherein the diameter of the insulating sleeve is 0.2-0.4 mm greater than the diameter of the spring and 0.05-0.1 mm less than the diameter of the socket, further the spring is against the insulating sleeve to restrict the reciprocating movement of the charging needle in the socket.

5. The device of claim 1, wherein two same-sized holes are drilled in the bracket and the socket respectively so as to make a charged wire able to pass through the socket and the bracket so as to charge the charging needle directly.

6. The device of claim 1, wherein the bracket is a rectangular frame and is connected with the ultrasonic horn using bolts and nuts, further the ultrasonic horn are fitted with a gasket.

7. The device of claim 1, wherein the ultrasonic horn and the transducer back cover are made of insulating ceramic materials.

8. The device of claim 1, wherein the transducer back cover, the piezoelectric ceramics, the transducer front cover and the ultrasonic horn constitute the main part of low-frequency electrostatic ultrasonic atomization nozzle with a vibration frequency range of 20-100 kHz.

9. The device of claim 1, wherein the charging needle applies a static voltage of less than 500-2000 V to the levitating ball.

10. The device of claim 1, wherein the diameter of the levitating ball is 15±2 mm.
